(19) United States
(12) Patent Application Publication
(10) Pub. No.: US 2017/0344254 A1
(43) Pub. Date: Nov. 30, 2017

(54) ELECTRONIC DEVICE AND METHOD FOR CONTROLLING ELECTRONIC DEVICE

(71) Applicant: Samsung Electronics Co., Ltd., Suwon-si, Gyeonggi-do (KR)

(72) Inventors: Guoliang ZHANG, Jiangsu (CN); Liexin CHEN, Jiangsu (CN)

(21) Appl. No.: 15/533,230

(22) PCT Filed: Nov. 11, 2015
(86) PCT No.: PCT/KR2015/012088

§ 371 Date: Jun. 5, 2017

(30) Foreign Application Priority Data
Jan. 19, 2015 (CN) 201510025705.3
Nov. 6, 2015 (KR) 10-2015-0155788

(51) Int. Cl. G06F 3/0488; G06F 3/14; G06F 3/0484

(52) U.S. Cl. CPC G06F 3/04886; G06F 3/1423; G06F 3/04847

(57) ABSTRACT

Disclosed are an electronic device and a method of controlling the electronic device. The method of controlling the electronic device including a plurality of screens includes receiving a user input via a second screen having a user interface independently updated from a first screen; and controlling an operation performed by the electronic device and displayed on the first screen based on the user input.

### TECHNICAL FIELD

Disclosed embodiments relate to an electronic device and a control method thereof, and more particularly, to a method of controlling an electronic device including a plurality of screens.

### BACKGROUND ART

Electronic devices have become requisite devices in people's lives and work. In particular, mobile electronic devices including smart phones and tablet personal computers (PCs) have become most frequently used by users.

Users have gotten used to controlling electronic devices with one hand while carrying the electronic devices. However, as screens of the electronic devices have increased, it is not so easy for users to control the electronic devices with one hand. Thus, a method whereby a user conveniently controls an electronic device with one hand is required.

### DETAILED DESCRIPTION OF THE INVENTION

### Technical Problem

As screens of electronic devices increase, a method whereby a user conveniently controls an electronic device with one hand is required.

### Technical Solution

In a method of controlling an electronic device according to disclosed embodiments, a user interface receives a user input through a second screen independently updated from a first screen and controls an operation performed by the electronic device and displayed on the first screen based on the received user input, and thus a user may conveniently control the electronic device with one hand.

### ADVANTAGEOUS EFFECTS OF THE INVENTION

An electronic device and a method of controlling the electronic device according to disclosed embodiments may allow a user to conveniently control the electronic device with one hand.

### DESCRIPTION OF THE DRAWINGS

FIG. 1 is a diagram showing an example of an electronic device, according to a disclosed embodiment.

FIGS. 2A through 2C are flowcharts of a method of operating an electronic device, according to a disclosed embodiment.

FIG. 3 is a diagram for describing a control method of an electronic device, according to a disclosed embodiment.

FIG. 4 is a diagram for describing a mapping relationship between a user input and an operation performed by an electronic device and displayed on a first screen, according to a disclosed embodiment.

FIG. 5 is a diagram showing an example of changing a parameter relating to a second screen, according to a disclosed embodiment.

FIG. 6 is a diagram for describing an example of dividing a second screen of an electronic device into a plurality of zones, according to a disclosed embodiment.

FIG. 7 is a diagram of an example of a keyboard displayed on a second screen, according to a disclosed embodiment.

FIG. 8 is a diagram for describing a method of differently displaying a user input received through a second screen on a first screen, according to a disclosed embodiment.

FIG. 9 is a diagram for describing a method of releasing a locked state of an electronic device, according to a disclosed embodiment.

FIGS. 10A through 10C are diagrams of an example in which a lock pattern is used in an electronic device, according to a disclosed embodiment.

FIGS. 11 and 12 are block diagrams showing a configuration of an electronic device, according to a disclosed embodiment.

FIGS. 13 and 14 are block diagrams showing configurations of electronic devices, according to another disclosed embodiment.

FIG. 15 is a flowchart of an example in which an electronic device receives a dragging user input, according to another disclosed embodiment.

FIG. 16 is a flowchart of an example in which an electronic device receives a tap input, according to another disclosed embodiment.

FIG. 17 is a flowchart of an example in which an electronic device receives a touch & hold input, according to another disclosed embodiment.

### BEST MODE

According to an aspect of an embodiment, a method of controlling an electronic device including a plurality of screens includes receiving a user input via a second screen having a user interface independently updated from a first screen; and controlling an operation performed by the electronic device and displayed on the first screen based on the user input.

The method may further include: pre-mapping the operation performed by the electronic device and displayed on the first screen and the user input; and displaying an operation corresponding to the user input on the first screen based on a mapping result.

The user input includes one of a dragging input on the second screen, a single tap input, a double tap input, and a touch & hold input.

The controlling of the operation includes: displaying a preset operation on the first screen based on the user input; and controlling user interfaces of the first screen and the second screen according to the displayed preset operation.

In the receiving of the user input, the user input includes: touching a key of a keyboard displayed on the second screen and wherein the controlling of the operation includes: displaying an operation determined based on a value corresponding to the touched key on the first screen.

The method may further include: changing a display format of the keyboard according to a user setting.

The method may further include: adaptively setting at least one of a location, a length, and a width of a zone that receives the user input via the second screen according to a user.

The method may further include: dividing the second screen into a plurality of zones and performing different operations according to user inputs received through the divided plurality of zones.

The method may further include: updating user interfaces of the first screen and the second screen based on state information of the first screen and the second screen, wherein the state information includes at least one of a locked state of the electronic device, a selected application, and information associated with an application being executed.

The method may further include: releasing a locked state of the electronic device based on a preset user input received through the second screen.

According to an aspect of another embodiment, an electronic device includes a display including a first screen and a second screen having a user interface independently updated from the first screen; a user input configured to receive a user input via the second screen; and a controller configured to control an operation performed by the electronic device and displayed on the first screen based on the user input.

The controller pre-maps the operation performed by the electronic device and displayed on the first screen and the user input and displays an operation corresponding to the user input on the first screen based on a mapping result.

The user input includes one of a dragging input on the second screen, a single tap input, a double tap input, and a touch & hold input.

The controller according to an embodiment of the present invention may display a preset operation on the first screen based on a user input and control user interfaces of the first screen and the second screen according to the displayed operation.

The user input includes touching a key of a keyboard displayed on the second screen, and wherein the controller displays an operation determined based on a value corresponding to the touched key on the first screen.

The controller according to an embodiment of the present invention may change a display format of a keyboard according to a user setting.

The controller according to an embodiment of the present invention may adaptively set at least one of a location, a length, and a width of a zone that receives the user input via the second screen.

The second screen according to an embodiment of the present invention may be divided into a plurality of zones, and the controller may perform different operations according to user inputs received through the divided plurality of zones.

The controller updates user interfaces of the first screen and the second screen based on state information of the first screen and the second screen, and wherein the state information includes at least one of a locked state of the electronic device, a selected application, and information associated with an application being executed.

### MODE OF THE INVENTION

Terms used in this specification will now be briefly described before describing the present invention.

Although most terms used in this specification are selected among currently popular general terms in consideration of functions implemented in the present invention, some terms are used based on the intentions of those of ordinary skill in the art, precedents, emergence of new technologies, or the like. Specific terms may be arbitrarily selected by the applicant and, in this case, the meanings thereof will be described in the detailed description of the invention. Thus, the terms used herein should be defined based on practical meanings thereof and the whole content of this specification, rather than based on names of the terms.

It will be understood that the terms “comprises”, “comprising”, “includes” and/or “including”, when used herein, specify the presence of stated elements, but do not preclude the presence or addition of one or more other elements.

The suffix such as “. . . er”, “unit”, or “module” is used to denote an entity for performing at least one function or operation, and may be embodied in the form of hardware, software, or a combination thereof.

Throughout the specification, the term “touch input” denotes a gesture of a user which is made on a touchscreen to control an electronic device. For example, the touch input may include a single tap, a double tap, a touch & hold, a drag, etc.

“Single tap” indicates an operation in which a user touches a screen using a finger or a touch tool (e.g., an electronic pen) and immediately lifts it from the screen without moving.

“Double tap” indicates an operation in which a user touches a screen twice using a finger or a touch tool (e.g., an electronic pen).

“Drag” means an operation of moving a finger or a touch tool to another location in a screen while a user holds the touch after touching the finger or the touch tool on the screen.

“Touch & hold” represents an operation in which a user touches a screen using a finger or a touch tool (e.g., an electronic pen) and then maintains a touch input over a threshold time (e.g., 2 seconds). For example, a time difference between touch-in and touch-out times is equal to or greater than the threshold time (e.g., 2 seconds). In order to allow the user to recognize whether the touch input is a tap or a touch & hold, a feedback signal may be provided visually, audibly, or tactually when the touch input is maintained for more than the threshold time. Further, the threshold time may be changed according to an embodiment.

Hereinafter, the present invention will be described in detail by explaining embodiments of the invention with reference to the attached drawings. The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art. In the drawings, elements irrespective of descriptions of the present invention are not illustrated, and like reference numerals denote like elements.

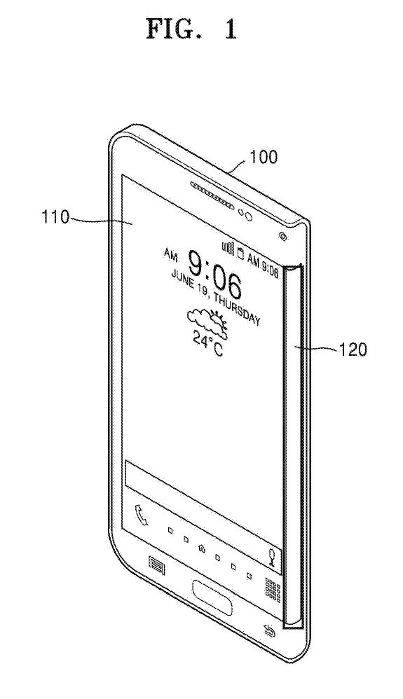

FIG. 1 is a diagram showing an example of an electronic device, according to a disclosed embodiment.

The electronic device 100 according to the disclosed embodiment may be implemented in various forms. For example, the electronic device 100 may be a mobile phone, a smart phone, a personal computer (PC), a tablet PC, a personal digital assistant (PDA), a smart television (TV), a laptop, a media player, an MP3 player, a digital camera, a kiosk, a navigation, a Global Positioning System (GPS) device, an electronic book terminal, a digital broadcast terminal, and another mobile or a non-mobile computing device but is not limited to. In addition, the electronic device 100 may be a wearable device such as a watch, eyeglasses, a hair band, and a ring with a communication function and a data processing function, but is not limited thereto.

Referring to FIG. 1, the electronic device 100 according to an embodiment may include a first screen 110 and a second screen 120.

As shown in FIG. 1, the first screen 110 and the second screen 120 may be configured as a single curved screen, or may be composed of a plurality of independent screens, but are not limited thereto. Further, the second screen 120 may be located on both sides of the electronic device 100, as shown in FIG. 1, but is not limited thereto.

A user interface of the second screen 120 may be updated independently from the first screen 110. For example, the first screen 110 may display an overall operation performed by the electronic device 100 and the second screen 120 may display a user interface for controlling an operation performed by the electronic device 100 and displayed on the first screen 110.

The electronic device 100 may receive a user input via the second screen 120 and control operations that are performed by the electronic device 100 and displayed on the first screen 110 based on the received user input.

For example, the electronic device 100 may pre-map the operations that are performed by the electronic device 100 and displayed on the first screen 110 for each of user inputs received via the second screen 120. The electronic device 100 may receive a user input including various touch inputs through the second screen 120. Then an operation corresponding to the user input may be performed by the electronic device 100 and displayed on the first screen 110 based on a result of mapping.

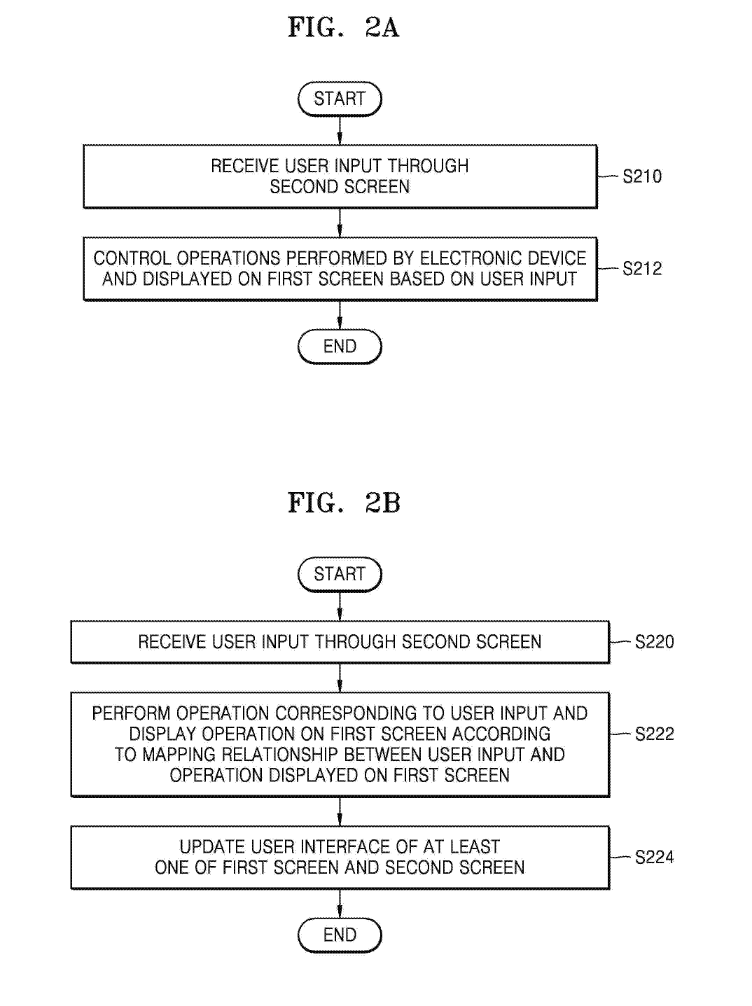

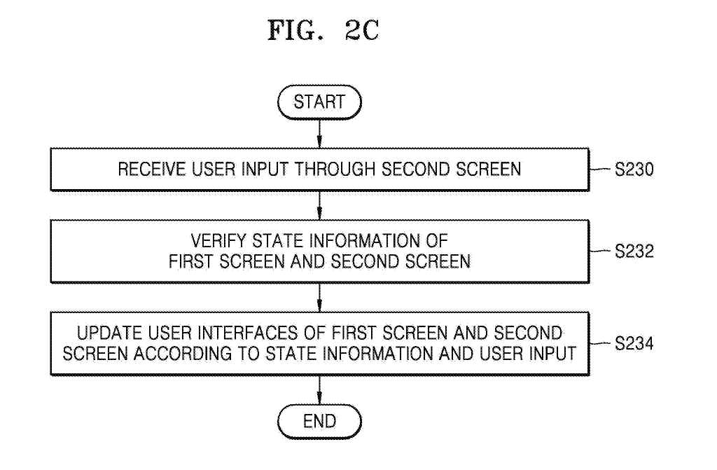

FIGS. 2A through 2C are flowcharts of a method of operating an electronic device, according to a disclosed embodiment.

Referring to 2A, in step S210, the electronic device 100 may receive a user input via the second screen 120. At this time, the user input may be a touch input including a drag, a single tap, a double tap, and a touch & hold, but is not limited thereto.

In step S212, the electronic device 100 may control operations that are performed by the electronic device 100 based on the user input and displayed on the first screen 110.

When the user input is received via the second screen 120, an operation corresponding to the user input may be performed by the electronic device 100 and displayed on the first screen 110. For example, when an input that is dragged down is received through the second screen 120, an operation of dragging a page downward may be performed by the electronic device 100 and displayed on the first screen 110.

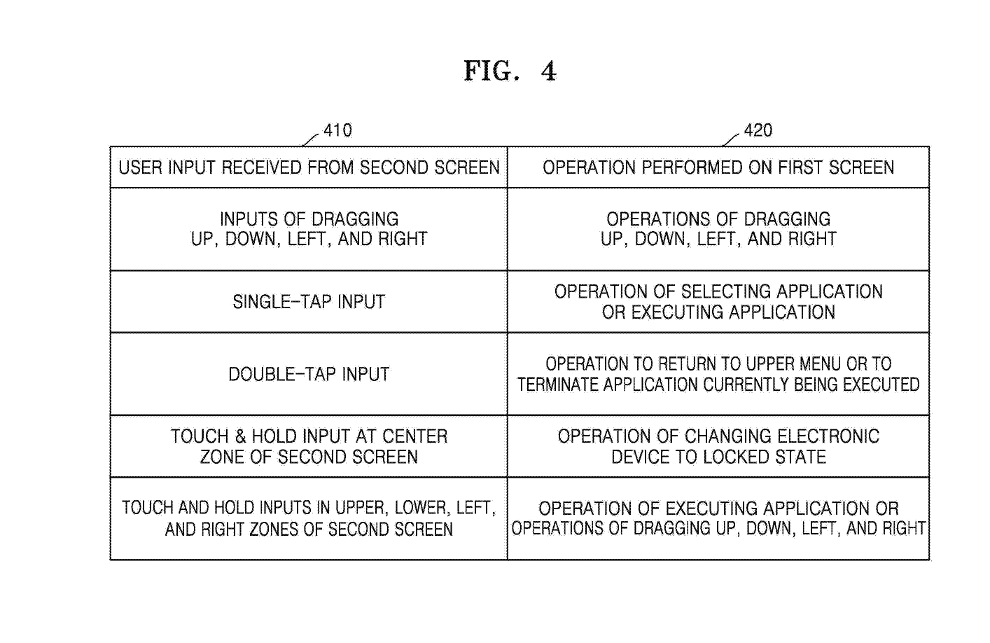

At this time, the electronic device 100 may pre-map each of user inputs received through the second screen 120 to an operation performed by the electronic device 100 and displayed on the first screen 110. A mapping relationship between the user input and the operation performed by the electronic device 100 and displayed on the first screen 110 may be stored in memory during a process of manufacturing the electronic device 100. Further, according to an embodiment, the mapping relation may be changed according to a setting of the user. The mapping between the user input and the operation performed by the electronic device 100 and performed on the first screen 110 will be described later with reference to FIG. 4.

The electronic device 100 may also be configured to display a predetermined operation on the first screen 110 based on the user input received via the second screen 120 and may update user interfaces of the first screen 110 and the second screen 120.

Referring to FIG. 2B, in step S220, the electronic device 100 may receive a user input via the second screen 120.

In step S222, the electronic device 100 may display an operation corresponding to the user input on the first screen 110 according to the mapping relationship between the user input received through the second screen 120 and the operations performed on the electronic device 100 and displayed on the first screen 110. Steps S220 and S222 are described in detail with reference to FIG. 2A, and thus redundant descriptions will be omitted.

In step S224, the electronic device 100 may update the user interface of at least one of the first screen 110 and the second screen 120 according to the operation displayed on the first screen 110. For example, when a single tap input is received from the second screen 120, an operation to execute a particular application may be performed by the electronic device 100 and displayed on the first screen 110. At this time, if the executed application requires a text input, the electronic device 100 may display a keyboard that may receive the text input on the second screen 120.

The electronic device 100 may also update the user interfaces of the first screen 110 and the second screen 120 based on state information as well as the user input.

Referring to 2C, the electronic device 100 may receive a user input through the second screen 120 (step S230) and may verify the state information of the first screen 110 and the second screen 120 (step S232).

The state information of the first screen 110 may include information related to whether the electronic device 100 is in a locked state, a page displayed on the first screen, a selected page, a selected application, and an application being executed.

For example, with regards to state information related to the application being executed, an initial value may be set to “−1”, and the initial value “−1” may mean that there is no application currently being executed. At this time, if a specific application is executed according to the user input, the electronic device 100 may update a serial number of the application being executed as new state information.

Also, with regards to state information related to the locked state of the electronic device 100, the initial value may be set to “YES”. Then, if the locked state of the electronic device 100 is released according to a user input, the electronic device 100 may update the state information related to the locked state.

In addition, a certain software screen (e.g., a home screen, a lock screen, or an application screen) of the electronic device 100 may include a plurality of pages. A plurality of application lists or an application being executed may be displayed on each page. Accordingly, the state information of the first screen 110 may include a number of a page currently displayed on the first screen 110. Also, the electronic device 100 may perform different operations according to the number of the currently displayed page even if the same user input is received.

The state information of the second screen 120 may include information about whether the second screen 120 is being used by a particular item, a type of an item displayed on the second screen 120, and the number of pages. At this time, the item may be a setting menu, a keyboard, or a predetermined application available to the user on the second screen 120, but is not limited thereto.

For example, when the keyboard is displayed on the second screen 120, the state information regarding the type of the item may be a serial number corresponding to the keyboard. Also, depending on a space constraint, the keyboard may be divided into a plurality of pages on the second screen 120, and a page number of the currently displayed keyboard may constitute state information.

In step S234, the electronic device 100 may update the user interfaces of the first screen 110 and the second screen 120, based on the state information of the first screen 110 and the second screen 120 and the user input.

For example, if there is a selected application and a single tap input is received via the second screen 120, the electronic device 100 may execute the selected application based on state information regarding the selected application and the user input. Further, if there is no selected application and a single tap input is received via the second screen 120, the electronic device 100 may be changed to the locked state. However, the operations performed based on the state information and the user input are not limited to the above-described examples.

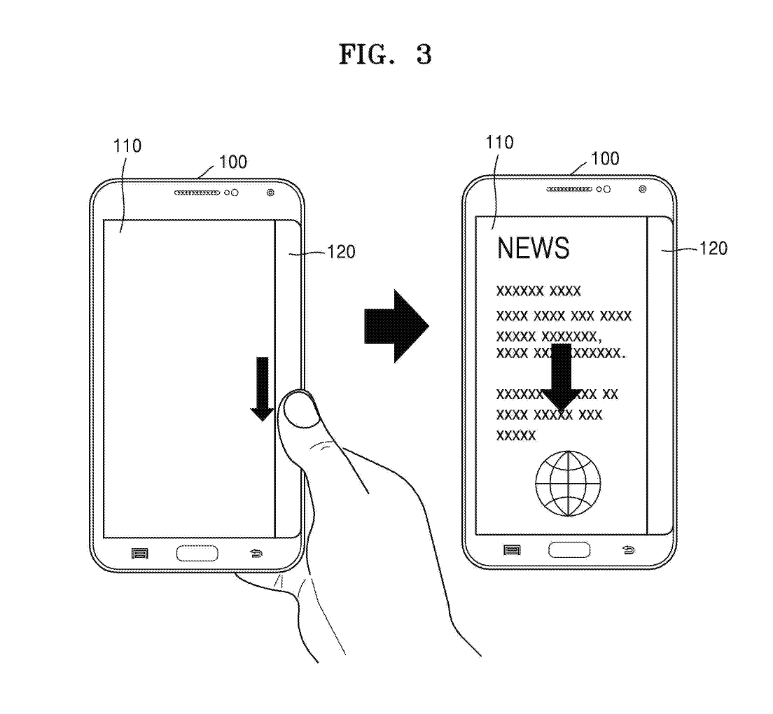

FIG. 3 is a diagram for describing a control method of an electronic device, according to a disclosed embodiment.

As described above, as a user input is dragged downward through the second screen 120, an operation of dragging the page downward may be performed by the electronic device 100 and displayed on the first screen 110.

For example, as shown in FIG. 3, as the dragging of the page downward is performed by the electronic device 100 and displayed on the first screen 110, a page displayed on the first screen 110 may be scrolled.

For example, if a page containing text is scrolled and bottommost text is displayed, the second screen 120 may return to a top menu or may display a user interface for receiving an input to end the currently displayed page.

FIG. 4 is a diagram for describing a mapping relationship between a user input and an operation performed by an electronic device and displayed on a first screen, according to a disclosed embodiment.

As described above, a user input 410 received via the second screen 120 may be a touch input including, but not limited to, a drag, a single tap, a double tap, and a touch & hold. Also, an operation 420 performed by the electronic device 100 and displayed on the first screen 110 according to the user input 410 may be mapped as shown in FIG. 4, but is not limited thereto.

Referring to FIG. 4, an input that is dragged on the second screen 120 may correspond to a drag operation performed by the electronic device 100 and displayed on the first screen 110. For example, when an input that is dragged in a specific direction is received through the second screen 120, an operation of dragging in the same direction may be performed by the electronic device 100 and displayed on the first screen.

Also, a single-tap input from the second screen 120 may correspond to an operation of selecting a specific application from a plurality of applications displayed on the first screen 110 or executing the selected application.

Further, an input that double-taps on the second screen 120 may correspond to an operation to return to an upper menu on the first screen 110 or to terminate application currently being executed.

Further, the electronic device 100 may divide the second screen 120 into a plurality of zones. Also, depending on a user input in each zone, different operations may be performed by the electronic device 100 and displayed on the first screen 100. For example, a touch & hold input at a center zone may correspond to an operation of changing the electronic device 100 to a locked state. Touch and hold inputs in upper, lower, left, and right zones of the second screen 120 may correspond to operations of dragging up, down, left, and right, respectively.

However, the mapping relationship described above is only one embodiment, and other operations may be performed according to an embodiment.

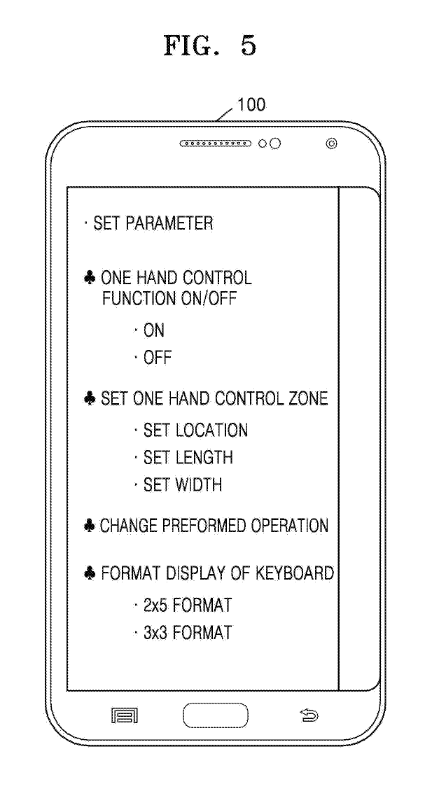

FIG. 5 is a diagram showing an example of changing a parameter associated with a second screen, according to a disclosed embodiment.

The electronic device 100 may change the parameter associated with the second screen 120 according to user settings.

The parameter associated with the second screen 120 may include on/off of “one hand control function”, as shown in FIG. 5. At this time, the “one-hand control function” may refer to a function that controls an operation performed by the electronic device 100 and displayed on the first screen 110, based on a user input received through the second screen 120, but other terms may be used depending on an embodiment. Hereinafter, for convenience of explanation, it is referred to as a hand control function.

In addition, the electronic device 100 may set at least one of a location, a length, and a width of a zone that receives a user input via the second screen 120, according to a user's hand. For example, if a size of the user's hand is small, at least one of the length and the width of the zone receiving the user input via the second screen 120 may be less than a current setting. Alternatively, the electronic device 100 may set the location of the zone receiving the user input via the second screen 120, depending on a user's grip state.

In addition, the electronic device 100 may recognize a user's repetitive gripping habit and adaptively set a zone that receives a user input through the second screen 120 based on the recognized gripping habit.

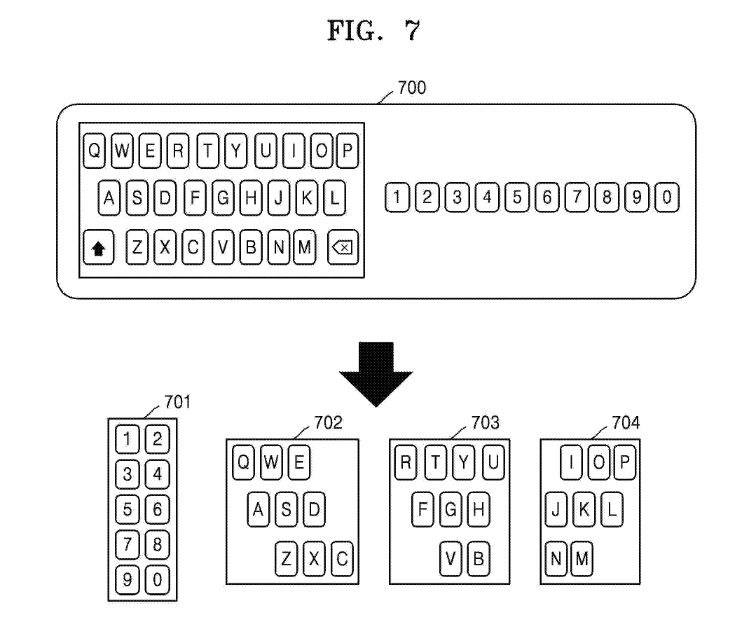

The electronic device 100 may change a display format of a keyboard displayed on the second screen 120. For example, the electronic device 100 may change the keyboard displayed on the second screen 120 to a format of 2×5, 3×3, etc. according to a setting of the user. The keyboard displayed on the second screen 120 will be described later with reference to FIG. 7.

In addition, as described above, the electronic device 100 may change a mapping relationship between the user input and the operation performed by the electronic device 100 and displayed on the first screen, depending on the convenience of the user.

A setting menu of the parameter associated with the second screen 120 may be displayed on the first screen 110, as shown in FIG. 5, but may be displayed on the second screen 120 according to an embodiment.

In addition, since the second screen 120 is relatively small in size compared to the first screen 110, when the setting menu is displayed on the second screen 120, the setting menu may be displayed in a drop-down menu and in an icon form but is not limited thereto.

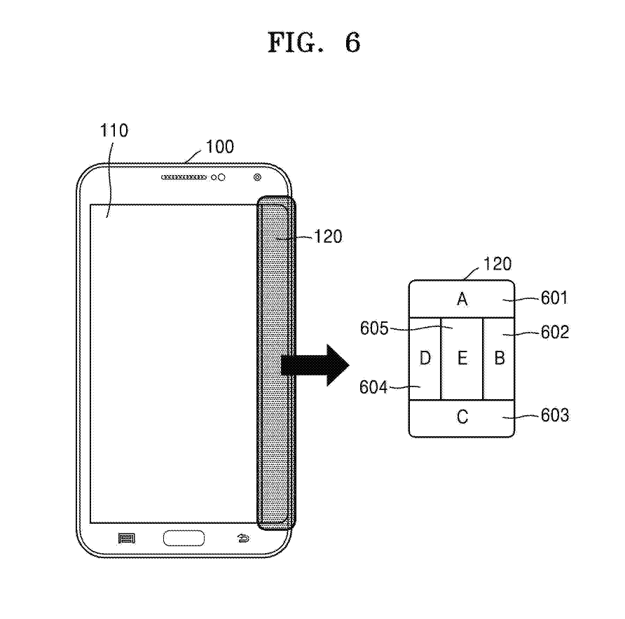

FIG. 6 is a diagram for describing an example of dividing a second screen of an electronic device into a plurality of zones, according to a disclosed embodiment.

Referring to FIG. 6, the second screen 120 may be divided into a plurality of zones. For example, as shown in FIG. 6, the second screen 120 may be divided into A (601), B (602), C (603), D (604), and E (605), but is not limited thereto.

The electronic device 100 may differently set operations performed by the electronic device 100 and displayed on the first screen 110, depending on a zone in which a user input is received. For example, as shown in FIG. 4, when a touch & hold input is received through the E zone (605), an operation of changing the electronic device 100 to a lock mode may be performed by the electronic device 100 and displayed on the first screen 110. Also, when a touch & hold input is received through one of A (601), B (602), C (603), and D (604), an operation of executing a currently selected application or dragging a page to a particular direction may be performed by the electronic device 100 and displayed on the first screen 110. However, the operations performed by the electronic device 100 and displayed on the first screen 110 in accordance with the user input are not limited to the above-described examples.

FIG. 7 is a diagram of an example of a keyboard displayed on a second screen, according to a disclosed embodiment.

The electronic device 100 may display a keyboard 700 receiving a user input on the second screen 120. At this time, the electronic device 100 may display numbers and English alphabets on the second screen 120 by dividing the numbers and the English alphabets into a plurality of pages. For example, as shown in FIG. 7, a first page of the keyboard 700 displayed on the second screen 120 may include numbers 701 displayed in a 2×5 format. Also, a second page may be displayed on a left portion 702 of the keyboard 700, a third page may be displayed on a center portion 703 of the keyboard 700, and a fourth page may be displayed on a right portion 704 of the keyboard 700. At this time, a portion of the keyboard 700 displayed on each page is not limited to the above-described example, and may be changed according to user settings. For example, when a display format of the keyboard is set to 3×3, a form and a page number of the keyboard displayed on the second screen 120 may differ from those shown in FIG. 7.

In addition, when an input to drag the keyboard displayed on the second screen 120 is received, the electronic device 100 may change a page of the keyboard currently being displayed. For example, if the first page 701 of the current keyboard is displayed, when a user input to drag right is received through the second screen 120, the electronic device 100 may display the second page 702 of the keyboard on the second screen 120. However, according to an embodiment, the user input for changing a page of the keyboard may be different and is not limited to the above-described example.

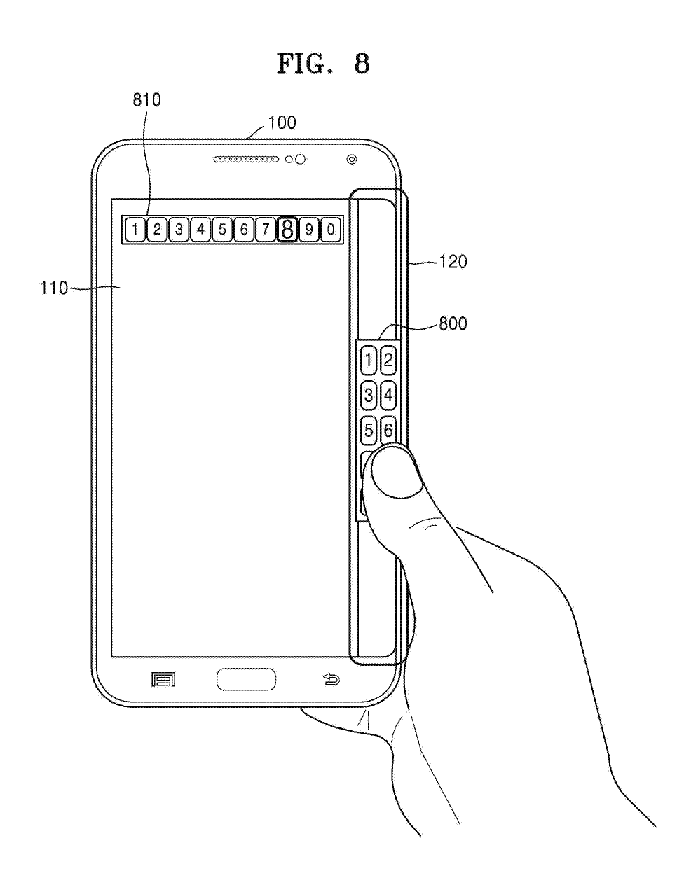

FIG. 8 is a diagram for describing a method of differently displaying a user input received through a second screen on a first screen, according to a disclosed embodiment.

When a keyboard 800 is displayed on the second screen 120, the electronic device 100 may control an operation performed by the electronic device 100 and displayed on the first screen 100 based on a user input that touches a key of the keyboard 800. At this time, the electronic device 100 may display the touched key on the first screen 110 in a distinguishable manner so that the touched key may be confirmed through the second screen 120.

For example, the electronic device 100 may display keys currently displayed on the second screen 120 on the first screen 110 and highlight the touched keys on the first screen 110. At this time, a method of displaying the touched keys with a highlight may include, but is not limited to, displaying a number in bold or displaying a different color. Also, the electronic device 100 may adjust transparency of the keys displayed on the first screen 110, according to the convenience of a user.

In addition, the electronic device 100 may display a key to be touched in a pop-up form on the first screen 110, according to an embodiment. The key displayed in the form of the pop-up may be displayed in a central zone of the first screen 110, or may be displayed on an edge zone of the first screen 110, but is not limited thereto.

In addition, the electronic device 100 may display a menu on the second screen 120 that may cancel an input of a key when the key that is not intended by the user is touched. For example, the menu for canceling the input of the key may be displayed on the second screen 120 together with the keyboard 800, but is not limited thereto.

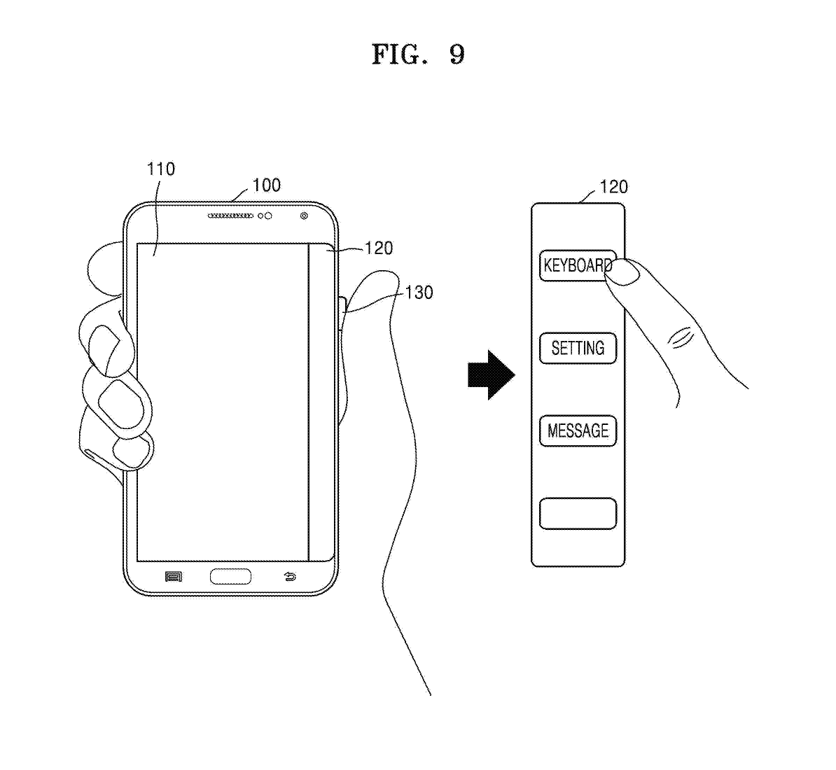

FIG. 9 is a diagram for describing a method of releasing a locked state of an electronic device, according to a disclosed embodiment.

Referring to FIG. 9, the electronic device 100 may include a button 130 on one side. However, a location of the button 130 is not limited to one side of the electronic device 100, and may be a top or a bottom of the electronic device 100.

When the electronic device 100 is in the locked state, the first screen 110 and the second screen 120 may be in an inactive state. At this time, as the button 130 is clicked, the electronic device 100 may activate the second screen 120. In order to release the lock state of the electronic device 100, a lock pattern or a password may be used, but is not limited thereto.

When the second screen 120 is activated, the electronic device 100 may display on the second screen 120 at least one item that the user may select. Referring to FIG. 9, an item displayed on the second screen 120 may include a keyboard that may be used to release the locked state of the electronic device 100.

For example, if a password is used, the keyboard may be selected to release the lock state of the electronic device 100. Then, as a key corresponding to the password is touched on the keyboard, the locked state of the electronic device 100 may be released.

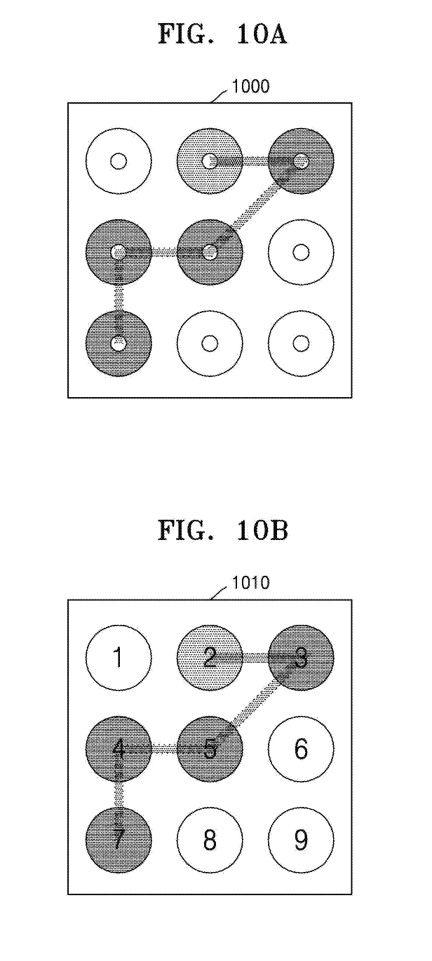

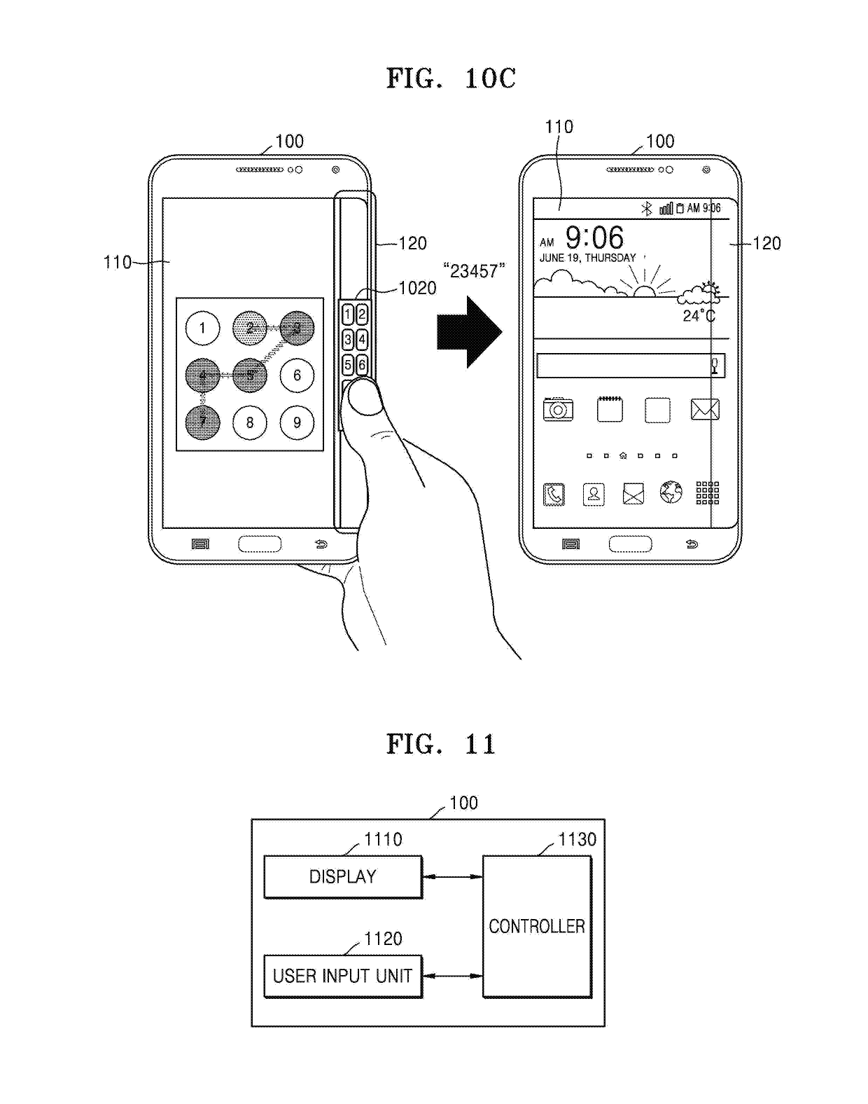

FIGS. 10A through 10C are diagrams of an example in which a lock pattern is used in an electronic device, according to a disclosed embodiment.

For example, in order to release a locking state of the electronic device 100, the lock pattern 1000 shown in FIG. 10A may be used. At this time, the lock pattern 1000 may be determined according to a setting of a user in a dot arrangement of 3×3 as shown in FIG. 10A. Also, according to an embodiment, the lock pattern may be set in a 4×4 or 5×5 dot arrangement, but is not limited thereto.

In general, since the second screen 120 is relatively small in size as compared with the first screen 110, a space for receiving a user input is narrow. Therefore, when the lock pattern 1000 is used, it is not easy to receive an input that draws the lock pattern 1000 set by the user through the second screen 120.

Accordingly, the electronic device 100 may map the lock pattern 1000 to a number arrangement. When numbers corresponding to the lock pattern are touched on a keyboard displayed on the second screen 120, the locked state of the electronic device 100 may be released.

For example, a 3×3 dot arrangement in which the lock pattern is set may be mapped to 1 through 9 numbers 1010 as shown in FIG. 10B. However, mapping relationships (1000, 1010) of each dot and numbers are not limited to the above-described example, and may be differently mapped according to an embodiment. When the lock pattern 1000 shown in FIG. 10A is mapped to a number arrangement 1010 shown in FIG. 10B, the lock pattern 1000 shown in FIG. 10A may correspond to a number arrangement “23547”.

FIG. 10C is a diagram illustrating an example in which a locked state of the electronic device is released as numbers corresponding to a lock pattern are touched.

As shown in FIG. 10C, when numbers are touched in order of “23547” in a keyboard 1020 displayed on the second screen 120, the electronic device 100 may recognize the lock pattern set by the user as inputted. Accordingly, the locked state of the electronic device 100 may be released.

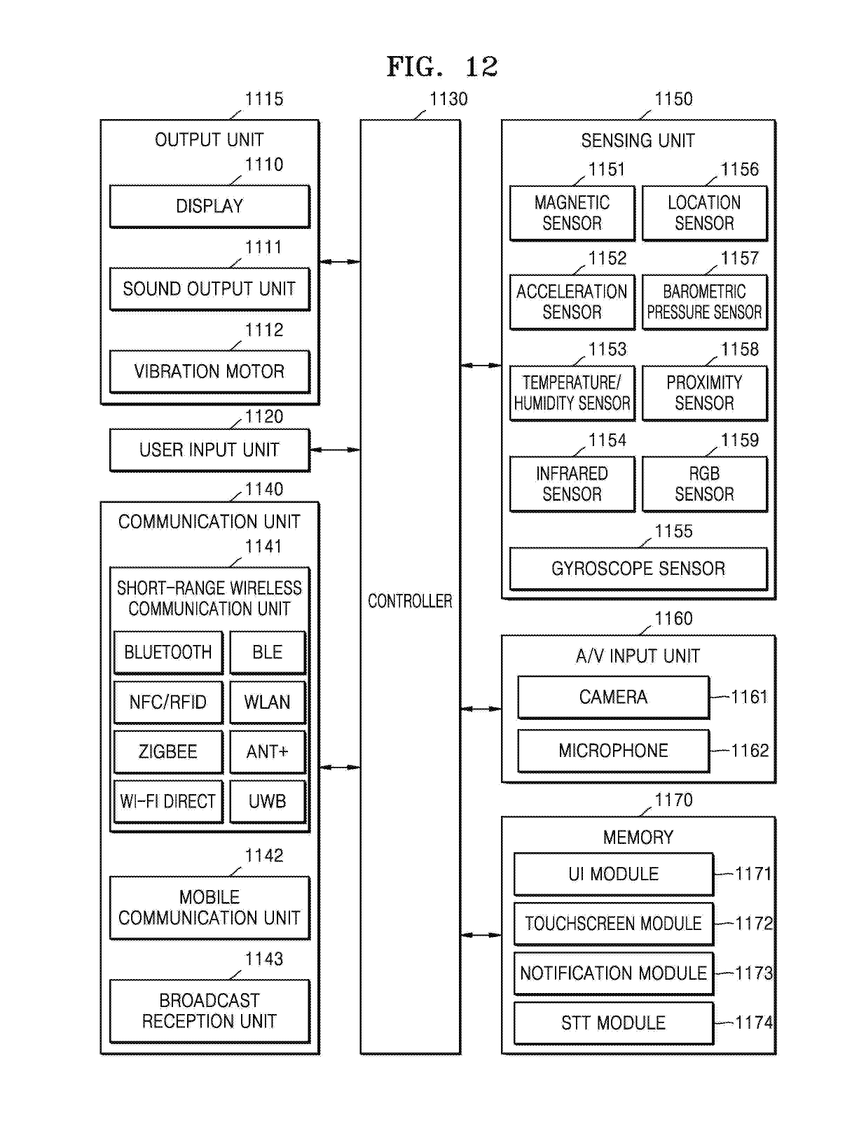

FIGS. 11 and 12 are block diagrams showing a configuration of an electronic device, according to a disclosed embodiment.

As shown in FIG. 11, the electronic device 100 according to a disclosed embodiment may include a display 1110, a user input unit 1120, and a controller 1130. However, all of the illustrated components are not essential. The electronic device 100 may be implemented by more components than those illustrated in FIG. 11 or less components than those illustrated in FIG. 11.

For example, as shown in FIG. 12, the electronic device 100 according to a disclosed embodiment may include a communication unit 1140, a sensor 1150, an A/V input unit 1160, and a memory 1170, in addition to the display 1110, the user input unit 1120, and the controller 1130.

The components will be described below.

An output unit 1115 is used to output audio signals, video signals, or vibration signals, and may include the display 1110, a sound output unit 1111, and a vibration motor 1112 but is not limited thereto.

The display 1110 may display information processed by the electronic device 100.

Also, the display 1110 may include the first screen 110 and the second screen 120. The first screen 110 and the second screen 120 may be configured as one curved screen or may be configured as a plurality of independent screens but are not limited thereto.

A user interface of the second screen 120 may be updated independently from the first screen 110. For example, the first screen 110 may display the overall operation performed on the electronic device 100 and the second screen 120 may display the user interface for an operation performed by the electronic device 100 and displayed on the first screen 110.

When the display 1110 and a touch pad have a layer structure and are configured as a touch screen, the display 1110 may be used as an input device in addition to an output device. The display 1110 may include at least one of a liquid crystal display, a thin film transistor-liquid crystal display, an organic light-emitting diode, a flexible display, a three-dimensional display 3D display, and electrophoretic display. In addition, depending on an implementation of the electronic device 100, the electronic device 100 may include two or more displays 1110.

The sound output unit 1111 outputs audio data received from the communication unit 1140 or stored in the memory 1170. In addition, the sound output unit 1111 outputs sound signals related to functions performed by the electronic device 100 (e.g., call signal reception sound, message reception sound, and notification sound). The sound output unit 1111 may include a speaker or a buzzer.

The vibration motor 1112 may output vibration signals. For example, the vibration motor 1112 may output vibration signals corresponding to output of video data or audio data (e.g., call signal reception sound and message reception sound). In addition, the vibration motor 1112 may output vibration signals when touches are input to the touch screen.

The user input unit 1120 refers to an element used when the user inputs data to control the mobile device 100b. For example, the user input unit 1120 may include a keypad, a dome switch, a touchpad (e.g., a capacitive overlay type, a resistive overlay type, an infrared beam type, a surface acoustic wave type, an integral strain gauge type, a piezoelectric type, etc.), a jog wheel, or a jog switch, but is not limited thereto. Also, the user input unit 1120 may include the touch screen.

The user input unit 1120 may receive a user input of controlling the first screen 110 through the second screen 120. For example, the user input may include one of various touch inputs including drag, single tap, double tap, and touch & hold input on the second screen 120. Also, the user input may include an operation of clicking the button 130 of the electronic device 100 but is not limited thereto.

The controller 1130 may control the general operation of the electronic device 100. For example, the controller 1130 may execute programs stored in the memory 1170 to generally control the output unit 1115, the user input unit 1120, the communication unit 1140, the sensor 1150, and the A/V input unit 1160, etc.

In addition, the controller 1130 may control an operation performed by the electronic device 100 and displayed on the first screen 110, based on a user input received through the second screen 120. For example, the controller 1130 may pre-map the user input and the operation performed by the electronic device 100 and displayed on the first screen 110. Based on a mapping result, an operation corresponding to the user input may be performed by the controller 1130 and displayed on the first screen 110. Also, when an input touching a key of a keyboard displayed on the second screen 120 is received, an operation determined based on a value corresponding to the touched key may be performed by the controller 1130 and may be displayed on the first screen 110. The controller 1130 may change a display format of the keyboard displayed on the second screen 120 according to user settings. For example, the controller 1130 may set the keyboard to a 3×3 or 2×5 format according to the convenience of a user but is not limited thereto.

In addition, the controller 1130 may display an operation corresponding to a user input on the first screen 110 and may control user interfaces of the first screen 110 and the second screen 120 according to the displayed operation.

The communication unit 1140 may include one or more components for performing communication between the electronic device 100 and an external device or between the electronic device 100 and a server. For example, the communication unit 1140 may include a short range communication unit 1141, a mobile communication unit 1142, and a broadcast reception unit 1143.

The short-range wireless communication unit 1141 includes a Bluetooth communication unit, a near field communication unit, a WLAN communication unit, a ZigBee communication unit, an IrDA (infrared data association) communication unit, A WFD (Wi-Fi Direct) communication unit, an UWB (ultra wideband) communication unit, an Ant+communication unit, and the like, but is not limited thereto.

The mobile communication unit 1142 transmits and receives wireless signals to and from at least one of a base station, an external terminal, and a server over a mobile communication network. In this regard, the wireless signal may include various types of data depending on a voice call signal, a video call signal, or a text/multimedia message transmission/reception.

The broadcast receiving unit 1143 receives broadcast signals and/or broadcast-related information from outside via a broadcast channel. The broadcast channel may include a satellite channel and a terrestrial channel. According to an embodiment, the electronic device 100 may not include the broadcast receiver 1143.

The sensing unit 1150 may sense a state of the electronic device 100 or a state around the electronic device 100 and may transmit sensed information to the controller 1130.

The sensing unit 1150 may include at least one of a magnetic sensor 1151, an acceleration sensor 1152, a temperature/humidity sensor 1153, an infrared sensor 1154, a gyroscope sensor 1155, (GPS) 1156, an air pressure sensor 1157, a proximity sensor 1158, and an RGB sensor (illuminance sensor) 1159, but is not limited thereto. A function of each sensor may be intuitively deduced from a name thereof by a person skilled in the art, and thus a detailed description thereof will be omitted.

The A/V input unit 1160 is used to input an audio signal or a video signal. The A/V input unit 1160 may include a camera 1161, a microphone 1162, and the like. The camera 1161 may obtain an image frame such as a still image or a moving image through an image sensor in a video communication mode or a photographing mode. An image captured through the image sensor may be processed through the controller 1130 or a separate image processing unit (not shown).

The image frame processed by the camera 1161 may be stored in the memory 1170 or transmitted to the outside through the communication unit 1140. The camera 1161 may be provided in two or more according to the configuration of the electronic device 100.

The microphone 1162 receives an external acoustic signal and processes the external acoustic signal as electrical voice data. For example, the microphone 1162 may receive acoustic signals from an external device or a speaker. The microphone 1162 may use various noise reduction algorithms for eliminating noise generated in receiving an external sound signal.

The memory 1170 may store a program for processing and controlling the controller 1130. Also, the memory 1170 may store input/output data (e.g., application, content, image file, text file, etc.).

The memory 1170 may include at least one storage medium of a flash memory type, a hard disk type, a multimedia card micro type, a card type memory (e.g., SD or XD memory) (Random Access Memory) SRAM (Static Random Access Memory), ROM (Read Only Memory), EEPROM (Electrically Erasable Programmable Read-Only Memory), PROM (Programmable Read-Only Memory), magnetic memory, a magnetic disk, and an optical disk. In addition, the electronic device 100 may operate a web storage or a cloud server that performs a storage function of the memory 1170 on the Internet.

The programs stored in the memory 1170 may be classified into a plurality of modules according to their functions. For example, the programs may be classified into a UI module 1171, a touch screen module 1172, a notification module 1173, a STT (Speak to Text) Module 1174, and the like.

The UI module 1171 may provide a specialized UI, a GUI, and the like that are interlocked with the electronic device 100 for each application. The touch screen module 1172 may sense a touch gesture on a touch screen of a user and may transmit information on the touch gesture to the controller 1130. The touch screen module 1172 may be configured as separate hardware including a controller.

Various sensors may be provided in or near the touch screen to detect a touch of the touch screen or a proximity touch. An example of a sensor for sensing the touch of the touch screen is a tactile sensor. The tactile sensor refers to a sensor that detects a contact of a specific object to a degree that a person feels or more than the degree. The tactile sensor may detect various pieces of information such as a roughness of a contact surface, a rigidity of a contact object, a temperature of a contact point, etc.

In addition, a proximity sensor is an example of a sensor for sensing the touch of the touch screen.

The proximity sensor refers to a sensor that detects a presence of an object approaching a predetermined detection surface, or a presence of an object in the vicinity of the detection surface, without using mechanical force by using electromagnetic force or infrared rays. Examples of proximity sensors may include transmission type photoelectric sensors, direct reflection type photoelectric sensors, mirror reflection type photoelectric sensors, high frequency oscillation proximity sensors, capacitive proximity sensors, magnetic proximity sensors, and infrared proximity sensors. User's touch gestures may include tap, touch & hold, double tap, drag, panning, flick, drag and drop, swipe, and the like.

The notification module 1173 may generate a signal for notifying an occurrence of an event of the electronic device 100. Examples of events generated in the electronic device 100 include call signal reception, message reception, key signal input, schedule notification, and the like. The notification module 1173 may output a notification signal in the form of a video signal through the display 1110 or may output a notification signal in the form of an audio signal through the sound output unit 1111, and outputs a notification signal in the form of a vibration signal.

The STT (Speech to Text) module 1174 may generate a transcript corresponding to multimedia content by converting a voice included in the multimedia content into text. At this time, the transcript may be mapped to reproduction time information of the multimedia content.

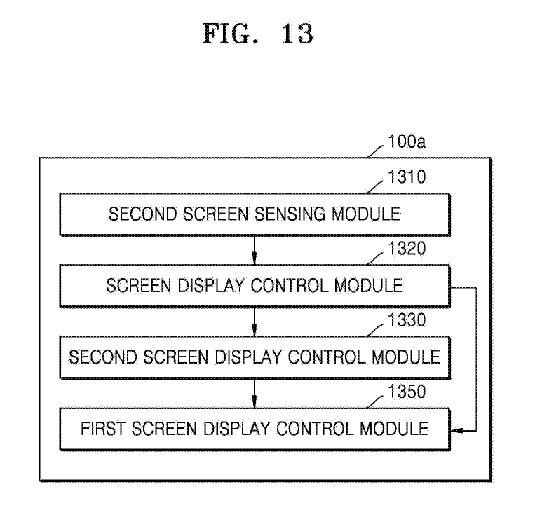

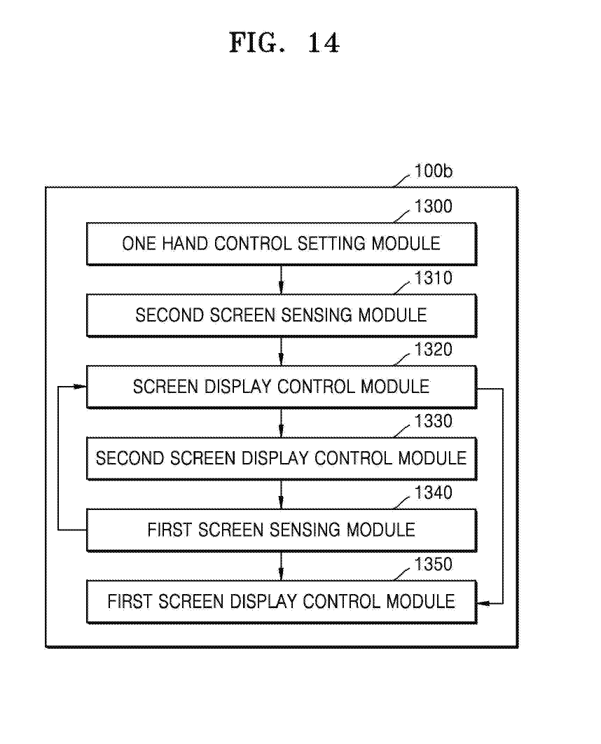

FIGS. 13 and 14 are block diagrams showing configurations of electronic devices, according to another disclosed embodiment.

An electronic device 100a according to another disclosed embodiment may include a second screen sensing module 1310, a screen display control module 1320, a second screen display control module 1330, and a first screen display control module 1350. According to an embodiment, the controller 1130 of FIGS. 11 and 12 may include the second screen detection module 1310, the screen display control module 1320, the second screen display control module 1330, and the first screen display control module 1350 of FIG. 13.

The second screen sensing module 1310 may sense a user input through the second screen 120.

The screen display control module 1320 may store a mapping relationship between the user input received via the second screen 120 and an operation performed by the electronic device 100 and displayed on the first screen 110. The screen display control module 1320 may also switch the user input sensed by the second screen sensing module 1310 to the operation performed by the electronic device 100 and displayed on the first screen 110.

In addition, the screen display control module 1320 may send the operation performed by the electronic device 100 and displayed on the first screen 110 to the first screen display control module 1350. The screen display control module 1320 may then update state information of the electronic device 100 and send the updated state information to the first screen display control module 1350 and the second screen display control module 1330.

The second screen display control module 1330 may update a user interface of the second screen 120 based on the received state information.

The first screen display control module 1350 may perform an operation received from the screen display control module 1320 and update the user interface of the first screen 110 based on the received state information.

However, according to an embodiment, an electronic device 100b may further include a hand control setting module 1300 and a first screen sensing module 1340 as shown in FIG. 14.

The one-hand control setting module 1300 may set and store parameters related to the second screen 120. For example, the one hand control setup module 1300 may set at least one of a location, length, and width of a zone that receives the user input via the second screen 120. The one-hand control setting module 1300 may also set a mapping relationship between the user input received via the second screen 120 and the operation performed by the electronic device 100 and displayed on the first screen 110.

The first screen sensing module 1340 may sense the user input received from the first screen 110 and may transmit the sensed user input to the screen display control module 1320. At this time, the user input may be one of a drag, a single tap, a double tap, and a touch & hold input, but is not limited thereto. The screen display control module 1320 may then transmit the user input sent from the first screen detection module 1340 to the first screen display control module 1350. The operation corresponding to the user input may be performed by the first screen display control module 1350 and displayed on the first screen 110.

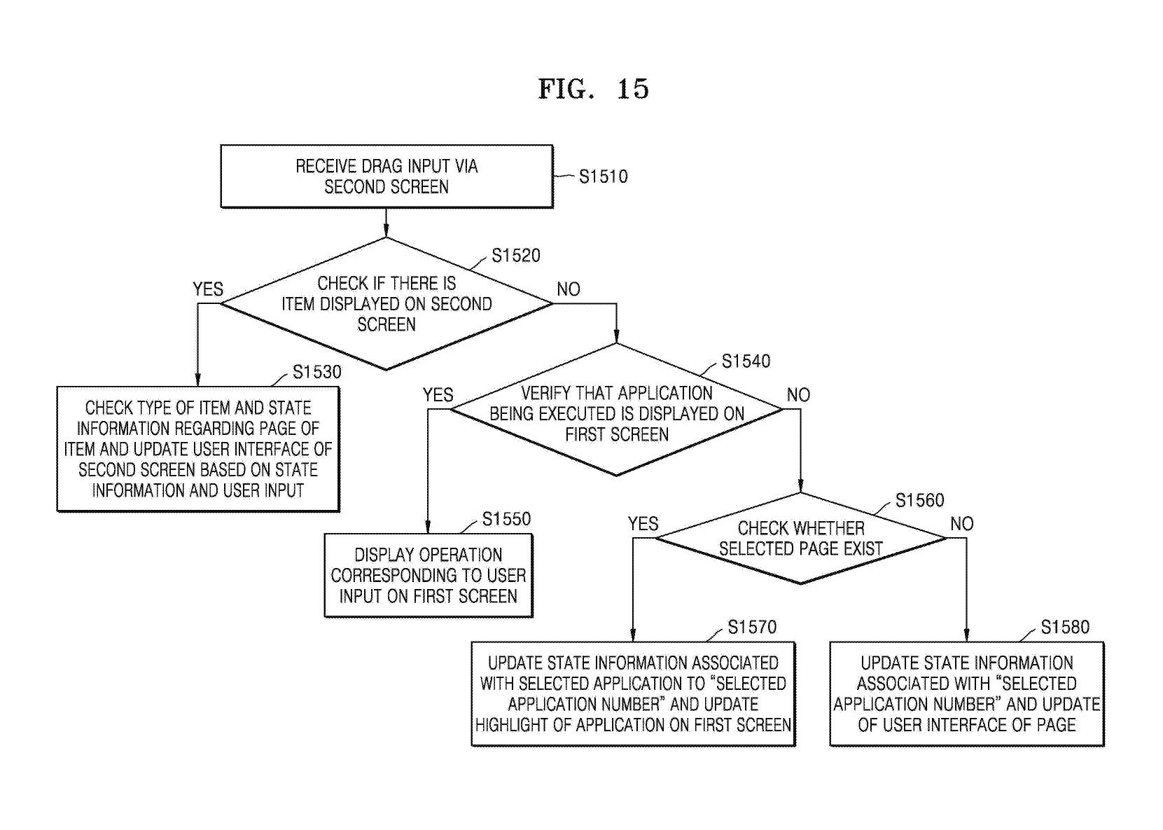

FIG. 15 is a flowchart of an example in which an electronic device receives a dragging user input, according to another disclosed embodiment.

In step S1510, the electronic device 100a may receive the drag input via the second screen 120.

In step S1520, the electronic device 100a may check if there is an item displayed on the second screen 120. The item displayed on the second screen 120 may include, but not limited to, a keyboard, a set menu of the electronic device 100a.

If there is the item displayed on the second screen 120 (step S1530), the electronic device 100a may check a type of an item and state information regarding a page of the displayed item.

For example, if the item displayed on the second screen 120 is a keyboard, the state information about the item type may be a serial number corresponding to the keyboard. Further, if a page of the keyboard currently displayed on the second screen 120 is a second page 702, state information regarding the page of the displayed item may be “2”.

The electronic device 100a may then update a user interface of the second screen 120 based on the confirmed state information and the received user input.

However, if there are no item displayed on the second screen 120 (step S1540), the electronic device 100a may verify that an application being executed is displayed on the first screen 110.

If there is the application being executed (step S1550), an operation corresponding to the user input may be performed by the electronic device 100a and displayed on the first screen 110. For example, when a downward dragging user input is received, an operation of dragging down with regard to the application being executed may be performed by the electronic device 100a and displayed on the first screen 110.

However, if there is no application being executed (step S1560), the electronic device 100a may check whether a currently selected page exists.

If there is a selected page (step S1570), the electronic device 100a may select one of a plurality of applications located on the selected page based on the user input. The electronic device 100a may then update state information associated with the selected application.

For example, each of a plurality of applications located on a particular page may include a unique serial number. Accordingly, when a specific application is selected based on the user input, the electronic device 100a may update a serial number of the selected application as state information. Then, the electronic device 100a may highlight the selected application.

However, if there is no selected page (step S1580), the electronic device 100a may change the page displayed on the first screen 110 based on the user input. For example, when a user input that is dragged to the left is received, the electronic device 100 may display a page located on a right side of the currently displayed page on the first screen 110. The electronic device 100a may then update the state information associated with the selected page.

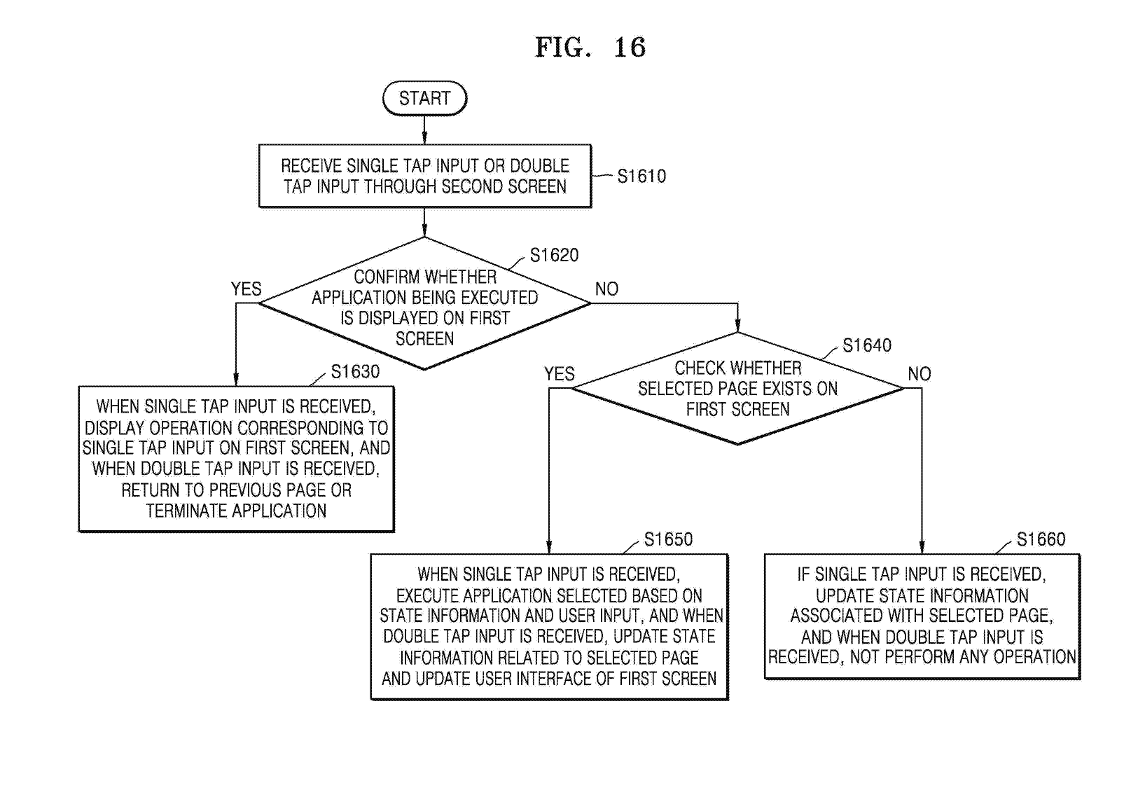

FIG. 16 is a flowchart of an example in which an electronic device receives a tap input, according to another disclosed embodiment.

In step S1610, the electronic device 100a may receive a single tap input or double tap input through the second screen 120.

Then, in step S1620, the electronic device 100a may confirm whether an application being executed is displayed on the first screen 110.

If there is an application being executed (step S1630), when the single tap input is received, an operation corresponding to the single tap input with respect to the application being executed may be performed by the electronic device 100a and displayed on the first screen 110. Then, when the double tap input is received, the electronic device 100a may terminate the application being executed or perform an operation of returning to a previous page of the application being executed and display the operation on the first screen 110.

However, if there is no application being executed (step S1640), the electronic device 100a may check whether a selected page exists.

If there is the selected page (step S1650), when the single tap input is received, an application selected based on state information and a user input may be executed by the electronic device 100a and displayed on the first screen 110. When the double tap input is received, the electronic device 100a may deselect the page and update state information related to the selected page. The electronic device 100a may also update a user interface of the first screen 110.

If there is no selected page (step S1660), if the single tap input is received, the electronic device 100a may select a page currently displayed on the first screen 110 and update state information associated with the selected page. When the double tap input is received, the electronic device 100a may not perform any operation.

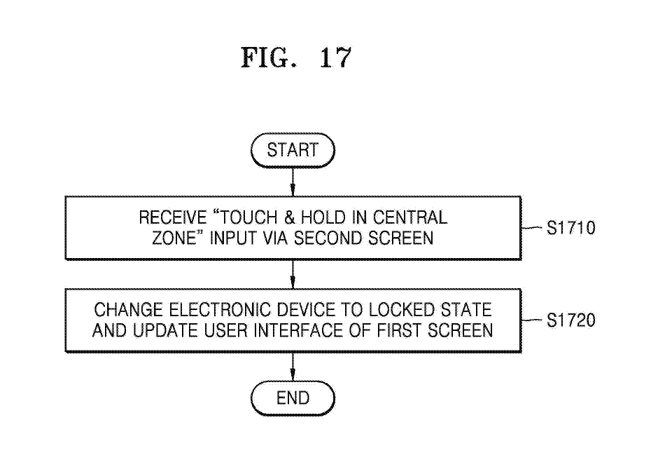

FIG. 17 is a flowchart of an example in which an electronic device receives a touch & hold input, according to another disclosed embodiment.

In step S1710, the electronic device 100a may receive a “touch & hold in a central zone” input via the second screen 120. The electronic device 100a then may switch the received user input to an operation performed by the electronic device 100 and displayed on the first screen 110. For example, the touch & hold in a central zone” input received via the second screen 120 may be switched to an operation of changing the electronic device 100a to a locked state.

In step S1720, the electronic device 100a may change the electronic device 100a to the locked state and update a user interface of the first screen 110.

The disclosed embodiment may be implemented in the form of program instructions that may be executed through various computer components and recorded on a non-transitory computer-readable recording medium. The non-transitory computer-readable recording medium may include program instructions, data files, data structures, or a combination thereof. The program instructions recorded on the computer-readable recording medium may be program instructions specially designed and configured for the present invention or program instructions known to and usable by one of ordinary skill in the art of computer software. Examples of the computer-readable recording medium include magnetic media (e.g., a hard disk, a floppy disk, and a magnetic tape), optical recording media (e.g., a CD-ROM and a DVD), magneto-optical media (e.g., a floptical disk), and hardware devices specially configured to store and execute program instructions (e.g., a ROM, a RAM, and a flash memory). Examples of the program instructions include machine code generated by a compiler and high-level language code that may be executed by a computer using an interpreter or the like.

It will be understood by those of ordinary skill in the art that the foregoing description of the present invention is for illustrative purposes only and that those of ordinary skill in the art may easily understand that various changes and modifications may be made without departing from the spirit or essential characteristics of the present invention. Therefore, it should be understood that the above-described embodiments are illustrative in all aspects and not restrictive. For example, each component described as a single entity may be distributed and implemented, and components described as distributed may also be implemented in a combined form.

The scope of the present invention is defined by the appended claims rather than the detailed description, and all changes or modifications derived from the meaning and scope of the claims and their equivalents are to be construed as being included within the scope of the present invention.

1. A method of controlling an electronic device comprising a plurality of screens, the method comprising:
receiving a user input via a second screen having a user interface independently updated from a first screen; and
controlling an operation performed by the electronic device and displayed on the first screen based on the user input.

2. The method of claim 1, further comprising:
pre-mapping the operation performed by the electronic device and displayed on the first screen and the user input; and
displaying an operation corresponding to the user input on the first screen based on a mapping result.

3. The method of claim 1, wherein the user input comprises one of a dragging input on the second screen, a single tap input, a double tap input, and a touch & hold input.

4. The method of claim 1, wherein the controlling of the operation comprises:
displaying a preset operation on the first screen based on the user input; and
controlling user interfaces of the first screen and the second screen according to the displayed preset operation.

5. The method of claim 1,
wherein, in the receiving of the user input, the user input comprises: touching a key of a keyboard displayed on the second screen and
wherein the controlling of the operation comprises: displaying an operation determined based on a value corresponding to the touched key on the first screen.

6. The method of claim 5, further comprising: changing a display format of the keyboard according to a user setting.

7. The method of claim 1, further comprising: adaptively setting at least one of a location, a length, and a width of a zone that receives the user input via the second screen according to a user.

8. The method of claim 1, further comprising: dividing the second screen into a plurality of zones and performing different operations according to user inputs received through the divided plurality of zones.

9. The method of claim 1, further comprising: updating user interfaces of the first screen and the second screen based on state information of the first screen and the second screen,
wherein the state information comprises at least one of a locked state of the electronic device, a selected application, and information associated with an application being executed.

10. The method of claim 1, further comprising: releasing a locked state of the electronic device based on a preset user input received through the second screen.

11. An electronic device comprising:
a display comprising a first screen and a second screen having a user interface independently updated from the first screen;
a user input configured to receive a user input via the second screen; and
a controller configured to control an operation performed by the electronic device and displayed on the first screen based on the user input.

12. The electronic device of claim 1, wherein the controller pre-maps the operation performed by the electronic device and displayed on the first screen and the user input and displays an operation corresponding to the user input on the first screen based on a mapping result.

13. The electronic device of claim 11, wherein the user input comprises one of a dragging input on the second screen, a single tap input, a double tap input, and a touch & hold input.

14. The electronic device of claim 11,
wherein the user input comprises touching a key of a keyboard displayed on the second screen, and
wherein the controller displays an operation determined based on a value corresponding to the touched key on the first screen.

15. The electronic device of claim 11, wherein the controller updates user interfaces of the first screen and the second screen based on state information of the first screen and the second screen, and
wherein the state information comprises at least one of a locked state of the electronic device, a selected application, and information associated with an application being executed.
